(19) United States
(12) Patent Application Publication
(10) Pub. No.: US 2007/0135577 A1
(43) Pub. Date: Jun. 14, 2007

(54) INTERMEDIATE ELASTOMER COMPOSITIONS

(76) Inventors: Terri A. Shefelbine, St. Paul, MN (US); Thu-Van T. Tran, Maplewood, MN (US)

Correspondence Address: 3M INNOVATIVE PROPERTIES COMPANY, PO BOX 33427, ST. PAUL, MN, 55133-3427, US

(21) Appl. No.: 11/275,097

(22) Filed: Dec. 9, 2005

(51) Int. Cl. C08L 27/12

(52) U.S. Cl. 525/199

(57) ABSTRACT

A plurality of crosslinked acrylate microspheres and a curable fluoroelastomer are combined to form a elastomeric blend of both materials. The microspheres are the reaction product of at least one acrylate monomer and at least one multifunctional crosslinking agent. The microspheres are crosslinked prior to being admixed with the curable fluoroelastomeric resin or gum. The combination is very beneficial to forming a final cured composition due to the elimination of the need to balance cure chemistries with the curing process kinetics.

### FIELD OF THE INVENTION

This invention relates to the preparation of elastomers, and more particularly to the combination of fluorocarbon elastomers with a plurality of crosslinked acrylate microspheres.

### BACKGROUND

Elastomer compositions are particularly useful as seals, gaskets, and molded parts in systems that are exposed to elevated temperatures, corrosive materials, or both. Such parts are used in applications such as automotive, chemical processing, semiconductor, aerospace, and petroleum industries, among others.

The formation of elastomeric articles generally involves combining a polymer resin or gum with one or more curatives to form a curable composition, shaping the curable mixture into a desired shape, and then curing the curable composition until the desired physical properties are achieved.

There are several different types of elastomers that are typically distinguished by the monomer units that are utilized to form the polymer resin or gum. For example, three commonly recognized types of elastomers include fluorocarbon elastomers, hydrocarbon elastomers, and silicone elastomers. The various types of elastomers are often classified by swell characteristics in a particular solvent and by their upper functional temperature limits. For example, fluorocarbon elastomers provide a significant advantage in that they are very resistant to solvents (as exhibited by low swell properties) and have relatively high upper temperature limits above 250° C. However, elastomers based on fluorocarbon polymers are typically costly and may at times exceed swell and temperature requirements for a given end use application. Both hydrocarbon polymer based elastomers and silicone elastomers are less costly to produce than fluorocarbon elastomers. However, the hydrocarbon elastomers generally are unable to attain the superior resistant to swell and upper temperature limitations relative the fluorocarbon elastomers.

There have been attempts to combine different types of elastomers in an effort to achieve beneficial properties comparable to, or even better than, those within a single, individual class. However, such attempts have not always resulted in enhanced elastomers. Often, certain classes of elastomers are incompatible with those of another class thus resulting in compositions with less than desirable physical characteristics. A few attempts at combination elastomers have resulted in elastomers suitable for specific end use applications. However, the process involved in forming the combinations have been hindered by the very difficult demands of balancing cure chemistries with processing kinetics.

### SUMMARY

The present invention addresses the issue of balancing cure chemistries with processing kinetics of elastomeric blends. The composition of the present invention utilizes a plurality of crosslinked acrylate microspheres and a curable fluoroelastomer to form an elastomeric blend of both materials. The microspheres are the reaction product of at least one acrylate monomer and at least one multifunctional crosslinking agent. The microspheres are crosslinked prior to being admixed with a curable fluoroelastomeric resin or gum.

The method of the present invention is carried out by blending the curable fluoroelastomer and the plurality of crosslinked acrylate microspheres. The microspheres are formed prior to creating the blend. The blending may actually occur as a dried blend of components or a latex blend of the components.

The blend of the present invention may include a curative to crosslink the fluoroelastomer. Additionally, the multifunctional crosslinking agent may be selected to interact with the fluoroelastomer to enhance the physical characteristics of the cured blend.

The novel combination of the present invention is very beneficial to forming a final composition due in part to the elimination of the need to balance cure chemistries with the curing process kinetics. Thus there is no multiple step vulcanization that may adversely affect one component of the elastomeric mixture.

### DETAILED DESCRIPTION

The composition of the present invention utilizes a plurality of crosslinked acrylate microspheres and a curable fluoroelastomer to form an elastomeric blend of both materials. The microspheres are the reaction product of at least one acrylate monomer and at least one multifunctional crosslinking agent. The microspheres are crosslinked prior to being admixed with a curable fluoroelastomeric resin or gum. The crosslinked acrylate microspheres are generally fixed in size and therefore significantly hinder coalescence during processing or aging of the admixture. The multifunctional crosslinking agent may enable the beneficial crosslinking of the microspheres with the fluorocarbon elastomer during the final curing process. The novel combination of the present invention is very beneficial to forming the final composition due in part to the elimination of the need to balance cure chemistries with the curing process kinetics. Thus there is no multiple step vulcanization that may adversely affect one component of the elastomeric mixture.

Microspheres

The crosslinked acrylate microspheres of the present invention are the reaction product of at least one acrylate monomer and at least one multifunctional crosslinking agent. The formed microspheres, as applied with the present invention, may have various degrees of crosslinking. Preferably, the microspheres are swellable, solvent-insoluble, and solvent dispersible thereby indicating a relatively high degree of crosslinking. Non-limiting examples of microspheres suitable for use in the present invention include those disclosed in U.S. Pat. No. 5,719,247 herein incorporated by reference in its entirety.

The microspheres are polymerized from one or more acrylate monomers. Alkyl acrylate esters and methacrylate esters are preferred acrylate monomers useful in preparing the microspheres of this invention and are selected from the group of monofunctional ethylenically unsaturated alkyl acrylate esters and alkyl methacrylate esters of non-tertiary alkyl alcohols, the alkyl groups of which have from about 4 to about 14 carbon atoms. Such monomers are oleophilic, water emulsifiable, have restricted water solubility, and as homopolymers, generally have glass transition temperatures below about −20° C. Included within this class of monomers are, for example, those monomers selected from at least one acrylate monomer is selected from 2 ethylhexyl acrylate, n-octyl acrylate, isooctyl acrylate, 4-methyl-2-pentyl acrylate, 2-methylbutyl acrylate, isoamyl acrylate, sec-butyl acrylate, n-butyl acrylate, isodecyl methacrylate, isononyl acrylate, isodecyl acrylate, tert-butyl acrylate, butyl methacrylate, and mixtures thereof.

Alkyl acrylate esters, alkyl methacrylate esters, or other free radically polymerizable monofunctional ethylenically unsaturated vinyl monomers which, as homopolymers, have glass transition temperatures higher than about −20° C., e.g., tert-butyl acrylate, isobornyl acrylate, butyl methacrylate, vinyl acetate, and the like, may be utilized in conjunction with one or more of the alkyl acrylate esters or alkyl methacrylate esters provided that the glass transition temperature of the resultant polymer is equal to or less than that of the desired fluoropolymer gum. Microspheres of the invention may be prepared using acrylate or methacrylate monomer(s) alone or in combination with other vinyl monomers, e.g., vinyl acetate, provided that the glass transition temperature of the resultant polymer is equal to or less than that of the desired fluoropolymer gum.

The microspheres of the invention may optionally further comprise a polar copolymerizable monomer or combinations thereof. The polar monomers selected preferably are copolymerizable with the alkyl acrylate esters, the alkyl methacrylate esters, or both. Examples of useful polar copolymerizable monomers include those selected from cyanoalkyl acrylates, acrylamides, substituted acrylamides, N-vinyl pyrrolidone, acrylonitrile, ammonium acrylate, and N-vinyl caprolactam.

The composition used to prepare the microsphere also contains a multifunctional crosslinking agent. The term “multifunctional” as used herein refers to crosslinking agents which possess two or more free radically polymerizable ethylenically unsaturated groups. Particularly useful multifunctional crosslinking agents include those selected from the group consisting of acrylic or methacrylic esters of diols such as butanediol, triols such as glycerol, and tetraols such as pentaerythritol. Other useful crosslinking agents include those selected from the group consisting of other multifunctional vinyl compounds and multifunctional acrylated oligomers. Preferred crosslinking agents include those selected from the group consisting of multifunctional (meth)acrylates, e.g., 1,4-butanediol diacrylate or 1,6-hexanediol diacrylate; penta erythritol tetra acrylate; polyvinylic crosslinking agents, such as substituted and unsubstituted divinylbenzene, polybutadiene diacrylate, or polyisoprene diacrylate; and difunctional urethane acrylates, such as Ebecryl™270 and Ebecryl™230 (1500 weight average molecular weight and 5000 weight average molecular weight acrylated polyurethanes, respectively—both available from UCB Chemicals Corp., Smyrna, Ga.).

The relative amounts of the above components are important to the properties of the resultant microsphere. The microspheres comprise about 40 to about 99.7 equivalent weight % alkyl acrylate ester(s), alkyl methacrylate ester(s), or mixtures thereof, optionally about 45 to about 1 equivalent weight % polar monomer; and about 10 to 0.3 equivalent weight % multifunctional crosslinking agent. Preferably, the microspheres of the invention comprise about 80 to about 99.7 equivalent weight % of alkyl acrylate or alkyl methacrylate ester or mixtures thereof, about 0 to about 20 equivalent weight % polar copolymerizable monomer, and about 0.3 to about 7.0 equivalent weight % of multifunctional crosslinking agent.

The crosslinked acrylate microspheres are the reaction product of a suspension or dispersion polymerization process using an aqueous or organic media. Processes for making microspheres are disclosed in U.S. Pat. Nos. 3,691,140; 4,166,152; 4,988,567; and 5,053,436; all of which are incorporated herein by reference in their entirety. Additionally U.S. Pat. No. 5,719,247, previously incorporated by reference, also discloses methods for making microspheres suitable for use in the present invention.

Fluoroelastomer

The present invention utilizes a curable fluoroelastomer composition as the continuous phase surrounding the plurality of microspheres. The fluoroelastomer composition may at least partially crosslink with the multifunctional crosslinking agent. Any curable fluoroelastomeric composition that is capable of such interaction with the crosslinking agent is suitable for use with the present invention. Preferred monomers that provide repeating units in the fluoroelastomer include two or more monomers selected from propylene, hexafluoropropylene (HFP), vinylidene difluoride (VDF), tetrafluoroethylene (TFE), and ethylene. Those skilled in the art are capable of selecting a particular monomer, or a combination of monomers, to render a fluoroelastomer suitable for a desired end use application.

In a most preferred embodiment, the fluoroelastomer is either a copolymer of HFP/VDF or a terpolymer of HFP, VDF, TFE. Those of skill in the art are capable of selecting a desired monomer ratio to enable a specific end use application.

Fluoropolymers suitable for use with the present invention are generally produced by conventional polymerization practices. The most preferred polymerization methods include suspension polymerization and aqueous emulsion polymerization. The aqueous emulsion polymerization normally involves the polymerization in the presence of a fluorine containing surfactant, which is generally used for the stabilization of the polymer particles formed. An aqueous polymerization with non-fluorine containing polymerization is also known. The suspension polymerization generally does not involve the use of surfactant but results in substantially larger polymer particles than in case of the aqueous emulsion polymerization. Thus, the polymer particles in case of suspension polymerization will quickly settle out whereas emulsion polymerization generally results in dispersions with good stability over time. Methods for fluoropolymer manufacturing are fully disclosed in U.S. Pat. Nos. 6,512,063, and 6,693,152, herein incorporated by reference in their entirety.

A curative is added to the elastomeric component in order to form a finished crosslinked article. The curable composition generally includes those known in the art for curing fluoroelastomer gums, and which should typically be selected so that they do not negatively impact the curing properties of the curable composition. Preferred curatives include those that enable curing through a polyol curing mechanism or a free radical curing mechanism. Polyol curing mechanisms may include polyhydroxy compounds such as bisphenols. According to a particular embodiment of the present invention, the composition for making a fluoroelastomer additionally comprises a polyhydroxy compound such that the composition may also be cured through a polyhydroxy cure system. In addition to the polyhydroxy compound, a polyhydroxy curing system generally also comprises one or more organo-onium accelerators. The organo-onium compounds useful in the present invention typically contain at least one heteroatom, i.e., a non-carbon atom such as N, P, S, O, bonded to organic or inorganic moieties and include for example ammonium salts, phosphonium salts and iminium salts. One class of quaternary organo-onium compounds useful in the present invention broadly comprises relatively positive and relatively negative ions wherein a phosphorus, arsenic, antimony or nitrogen generally comprises the central atom of the positive ion, and the negative ion may be an organic or inorganic anion (e.g., halide, sulfate, acetate, phosphate, phosphonate, hydroxide, alkoxide, phenoxide, bisphenoxide, etc.). Free radical curing includes the composition for making a fluoroelastomer also includes a free radical generating compound. By the term “free radical generating compound” is meant a compound that upon exposure to heat or actinic radiation such as for example UV, X-ray, β-ray radiation decomposes and thereby forms radicals. Typically, the free radical generating compound is a compound capable of initiating a free radical polymerization upon heating, a so called thermal initiator, or upon exposure to light, a so called photoinitiator. Examples of free radical generating compounds include, for example, persulfates such as ammonium persulfate alone or in combination with a suitable reducing agent such as a bisulfite or iron or copper; azo compounds such as for example azoisobutyronitrile.

In a preferred embodiment, the free radical generating compound is an organic peroxide. Suitable organic peroxides are those which generate free radicals at the desired curing temperatures. A dialkyl peroxide or a bis(dialkyl peroxide) which decomposes at a temperature above 50° C. is especially preferred. In many cases it is preferred to use a di-tertiarybutyl peroxide having a tertiary carbon atom attached to peroxy oxygen. Among the most useful peroxides of this type are 2,5-dimethyl-2,5-di(tertiarybutylperoxy)hexyne-3 and 2,5-dimethyl-2,5-di(tertiarybutylperoxy)hexane. Other peroxides can be selected from such compounds as dicumyl peroxide, dibenzoyl peroxide, tertiarybutyl perbenzoate, α,α′-bis(t-butylperoxy-diisopropylbenzene), and di[1,3-dimethyl-3-(t-butylperoxy)-butyl]carbonate. Generally, about 1-3 parts of peroxide per 100 parts of fluoropolymer is used.

To obtain a curable composition, there should generally also be present a coagent which has one or more groups that are capable of participating in a free radical cure reaction. Preferably, a coagent is composed of a polyunsaturated compound which is capable of cooperating with the free radical generating compound and the organic compound having MH functions to provide a useful cure. These coagents can be added in an amount equal to 0.1 and 10 parts per hundred parts fluoropolymer, preferably between 2-5 parts per hundred parts fluoropolymer. Examples of useful coagents include triallyl cyanurate; triallyl isocyanurate; triallyl trimellitate; tri(methylallyl)isocyanurate; tris(diallylamine)-s-triazine, triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane N,N′-m-phenylene bismaleimide; diallyl-phthalate and tri(5-norbornene-2-methylene)cyanurate. Particularly useful are triallyl isocyanurate and tri(methylallyl)isocyanurate. Other useful coagents include the bis-olefins disclosed in EPA 0 661 304 A1, EPA 0 784 064 A1 and EPA 0 769 521 A1.

Generally, the effective amount of curative, which may include more than one composition, is at least about 0.1 parts curative per hundred parts of the curable composition on a weight basis (phr), more typically at least about 0.5 phr. The effective amount of curative is typically below about 10 phr, (more typically below about 5 phr), although higher and lower amounts of curative may also be used.

The composition of the present invention may optionally include adjuvants generally recognized as suitable in elastomeric applications. Adjuvants such as, for example, carbon black, stabilizers, plasticizers, lubricants, fillers including silica and fluoropolymer fillers (e.g., PTFE and/or PFA (perfluoroalkoxy) fillers), and processing aids typically utilized in fluoropolymer compounding may be incorporated into the compositions, provided that they have adequate stability for the intended service conditions and do not substantially interfere with curing of the curable composition.

The curable composition can typically be prepared by mixing the plurality of crosslinked acrylate microspheres, one or more fluoroelastomers in a dried gum state, any selected adjuvant or additives, any additional curatives in conventional rubber processing equipment. The desired amounts of compounding ingredients and other conventional adjuvants or ingredients can be added to the curable composition and intimately admixed or compounded therewith by employing any of the usual rubber mixing devices such as internal mixers, (e.g., Banbury mixers), roll mills, extruder, or any other convenient mixing device. The temperature of the mixture during the mixing process typically is kept safely below the curing temperature of the composition. Thus, the temperature typically should not rise above about 120° C. During mixing, it generally is desirable to distribute the components and adjuvants uniformly throughout the gum.

In an alternative embodiment, both the microspheres and the fluoroelastomer may be blended in the latex form. Suspensions of each individual component are typically mixed and allowed to coagulate on their own with or without the addition of any coagulant.

The curable composition is then shaped, for example, by extrusion (e.g., into the shape of a film, tube, or hose) or by molding (e.g., in the form of sheet, gasket, or an O-ring). The shaped article is then typically heated to cure the curable fluoropolymer composition and form a useful article.

Surprisingly, it is discovered that the combination of curable fluoroelastomers and the crosslinked acrylate microspheres of the present invention result in a beneficial elastomeric blend. The microspheres are crosslinked prior to creating the admixture with the curable fluoroelastomer. This essentially fixes the size of the microspheres and thus prevents coalescence during processing or aging of the blend prior to a final curing stage. The pre-curing of the microspheres prior to forming then admixture eliminates the need to balance curing and processing kinetics. Specifically, a multiple step vulcanization of the admixture is avoided through the present invention. This prevents any potential adverse effects on the component of the admixture.

The resulting blend possesses desirable physical characteristics and reduced cost. For example, the temperature resistance of a fluoroelastomeric blend according to the present inventions, as measured by ASTM D2000, is greater than 150° C. Additionally, the composition exhibits a swell according to ASTM D471 in IRM 903 of about 15 percent or less. Additionally, the microspheres have a gel content of 97% or more.

### EXAMPLES

### Example 1

Materials

| Abbreviation | Description |
|---|---|
| Standpol A | ammonium lauryl sulfate availabe from Henkel. |
| Lucidol-75 | benzoyl peroxide available from Atochem N.A. |
| 2-EHA | 2-ethylhexylacrylate |
| IBOA | isobornyl acrylate |
| 1,4 BDA | 1,4 butane diol diacrylate |
| FE5640 | 65.9% fluorine copolymer of hexafluoropropylene |
| | and vinylidene fluoride with curatives incorporated. |
| | Available from Dyneon L.L.C. |
| BRE7232 | 60.0% fluorine terpolymer of hexafluoropropylene, |
| | vinylidene fluoride, and propylene with curatives |
| | incorporated. Available from Dyneon L.L.C. |
| FLS-2650 | 70.3% fluorine terpolymer of hexafluoropropylene, |
| | vinylidene fluoride, and tetrafluoroethylene that is |
| | curable by a peroxide system. Available from Dyneon |
| | L.L.C. |
| Calcium | Powder. Available from C.P. Hall |
| hydroxide HP | |
| Elastomag 170 | Magnesium oxide powder. Available from Akrochem. |
| N990 MT | Carbon black. Available from Degussa Engineered |
| | Carbons. |
| TAIC, 72% | 72% triallylisocyanurate on silica carrier. |
| DLC | Accelerator available from Mitsubishi. |
| Varox | 50% 2,5 dimethyl-2,5-di(t-butylperoxy) hexane on inert |
| DBPH-50% | filler. Availabe from R.T. Vanderbilt. |

In a one-liter resin flask (reactor), 487.5 grams of deionized water and 10.5 grams of Standapol A were mechanically mixed at 325 rpm and heated to 68° C. At 68° C., a premix of 257.25 grams of 2-EHA, 5.25 grams of 1,4-BDA and 1.05 grams of Lucidol-75 were added into the reactor. The temperature was lowered to 65° C. and the reactor was degassed and refilled with N₂ gas to induce the polymerization. After 20 minutes, the reaction started and the exothermic temperature reached to 86.8° C. After the temperature dropped to 65° C., the reactor was stirred for 10 hours to complete the polymerization. The reactor was allowed to cool to room temperature. Optical microscopy revealed the microspheres having average diameter of about 50.0 microns and their gel content was measured at 99.09% in heptane solvent. Microspheres were collected by coagulating the suspension in IPA. Microspheres were allowed to dry in air before processing. These microspheres are designated MS-1 in the following tables.

In a one-liter resin flask, 487.5 grams of deionized water and 10.5 grams of Standapol A were mechanically mixed at 430 rpm and heated to 68° C. When the temperature of the mixture reached 68° C., a premix of 249.38 grams of 2-EHA, 7.86 grams of IBOA, 5.25 grams of 1,4-BDA and 1.05 grams of Lucidol-75 were added into the reactor. The temperature was lowered to 65° C. and the reactor was degassed and refilled with N₂ gas to induce the polymerization. After 25 minutes, the reaction started and the exothermic temperature reached to 82.7° C. After temperature dropped to 65° C., the reactor was stirred for 10 hours to complete the polymerization. Then the reactor was allowed to cool to room temperature. Optical microscopy revealed the microspheres having average diameter of about 45.0 microns and their gel content was measured at 99.49% in heptane solvent. Microspheres were collected by coagulating the suspension in IPA. Microspheres were allowed to dry in air before processing. These microspheres are designated MS-2 in the following tables.

TABLE 1-1

| Microsphere | 2-EHA wt. % | IBOA wt. % | 1,4 BDA wt. % |
|---|---|---|---|
| MS-1 | 98 | 0 | 2 |
| MS-2 | 95 | 3 | 2 |

Compounds of three different fluoroelastomers with the microspheres described above were prepared on an open-roll according to the formulations in Table 2. The microspheres were added to the raw gum and mixed thoroughly followed by the addition of the rest of the ingredients. Compounds were removed from the mill in slabs of appropriate thickness for compression molding. The compounds were press-cured into 6″×6″ tensile sheets at 177° C. for 10 minutes. After the sheets were removed from the mold, the samples were post cured for 16 hours at 232° C.

TABLE 1-2

Compound #

| | A | B | C | D |
|---|---|---|---|---|
| FE5640 | 100.00 | 100.00 | | |
| BRE7232 | | | 100.00 | |
| FLS-2650 | | | | 100.00 |
| N990 MT Black | 30.00 | 30.00 | 30.00 | 30.00 |
| Elastomag 170 | 3.00 | 3.00 | 3.00 | 2.50 |
| Ca(OH)2 | 6.00 | 6.00 | 6.00 | 3.00 |
| TAIC, 72% DLC | | | | 2.50 |
| Varox DBPH-50% | | | | 2.50 |
| MS1 | 20.00 | | | 20.00 |
| MS2 | | 20.00 | 20.0 | |

The hot oil swelling resistance and hot air resistance were determined according to ASTM D471-98 and ASTM D2000, respectively. The physical properties of tensile strength at break, elongation at break, and hardness are listed in Table 2 for the post cured compounds. After the compounds were aged in air at 175° C. for 70 hrs, the change in tensile strength at break, elongation at break, and hardness were measured and are recorded in Table 2.

TABLE 2

| | Compound # | | | |
|---|---|---|---|---|
| | A | B | C | D |
| Physical properties of post | | | | |
| cure samples | | | | |
| Tensile (PSI) | 1122.3 | 1128.7 | 1247.8 | 856.6 |
| Elongation (%) | 157.7 | 177.0 | 150.2 | 244.8 |
| Duro, Shore “A” | 72.0 | 75.0 | 73.0 | 74.0 |
| Hot air heat age at | | | | |
| 175° C., 70 hours | | | | |
| Tensile (% change) | 24.2 | 18.4 | 12.8 | 24.3 |
| Elongation (% change) | 4.7 | 8.5 | 22.7 | 4.7 |
| Duro, Shore “A” (points change) | 3.0 | 4.0 | 7.0 | 0.0 |
| Vol. swell IRM 903, | | | | |
| 150 C., 70 hours | | | | |
| volume swell % | 7.3 | 3.4 | 13.0 | 7.9 |

In all four examples A, B, C, and D the change in tensile strength is less than 30% and elongation is less than 50% at 175° C., which classifies them as Type E according to ASTM 2000. The volume swells of compounds A, B, and D classify them as Class K. Compound C is Class J. All four compounds show good heat resistance at 175° C. and low volume swell.

### Example 2

Materials

| | |
|---|---|
| Fluoroelastomer | Copolymer of hexafluoropropylene, vinylidene |
| terpolymer latex | fluoride, and tetrafluoroethylene 70.2% Fluorine |
| BF6 | Bisphenol AF |
| TPBPCL/BF6 complex | Triphenylbenzyl phosphonium chloride |
| | complexed with bisphenol AF |
| TARSCl/BF6 complex | Triarylsulfonium chloride complexed with |
| | bisphenol AF |
| Calcium hydroxide HP | Powder. Available from C.P. Hall |
| Elastomag 170 | Magnesium oxide powder. Available from |
| | Akrochem. |
| N990 MT | Carbon black. Available from Degussa |
| | Engineered Carbons. |

In a one-liter resin flask (reactor), 487.5 grams of deionized water and 10.5 grams of Standapol A were mechanically mixed at 325 rpm and heated to 68° C. At 68° C., a premix of 257.25 grams of 2-EHA, 5.25 grams of 1,4-BDA and 1.05 grams of Lucidol-75 were added into the reactor. The temperature was lowered to 65° C. and the reactor was degassed and refilled with N₂ gas to induce the polymerization. After 20 minutes, the reaction started and the exothermic temperature reached to 83.2° C. After the temperature dropped to 65° C., the reactor was stirred for 10 hours to complete the polymerization. The reactor was allowed to cool to room temperature. Optical microscopy revealed the microspheres having particle size up to 100 um in diameter and their gel content was measured at 97.59% in heptane solvent.

In a 3 L beaker 810.56 g of a FKM terpolymer latex at 37.01% solids is mixed with 80.62 g of a suspension of 2-EHA/BDA 98:2 wt. % crosslinked acrylic microspheres at 37.2% solids. This ratio gives solids content of 100 parts FKM and 10 phr crosslinked acrylic microspheres. The solids of both solutions coagulate. Additional of 200 g of MgCL2 solution at 2% solids is added to complete the coagulation. The mixture is filtered and dried overnight in the oven at 55° C. and labeled C. The solids composition in parts per hundred rubber for the co-coagulated mixture is shown in Table 2-1.

TABLE 2-1

| Mixture # | C |
|---|---|
| FKM Terpolymer | 100 |
| 2-EHA/BDA | 10 |
| Microspheres | |

The co-coagulated mixture is compounded according to the formulations in Table 2-2, press cured at 177° C. for 10 minutes under pressure in a mold to make 6″6″ sheet. The sheet was then post cured at 232° C. for 16 hours.

TABLE 2-2

| | Compound # |
|---|---|
| | E |
| 2C | 110 |
| BF6 | 2.39 |
| TArSCl/BF6 complex | 1.24 |
| TPBPCl/BF6 complex | 0.88 |
| N990 MT Black | 30 |
| Elastomag 170 | 3 |
| Ca(OH)2 | 6 |

The hot oil swelling resistance and hot air resistance were determined according to ASTM D471-98 and ASTM D2000, respectively. The physical properties of tensile strength at break, elongation at break, and hardness are listed in Table 2-3 for the post cured compounds. After the compound was aged in air at 175° C. for 70 hrs, the change in tensile strength at break, elongation at break, and hardness were measured and are recorded in Table 2-3.

TABLE 2-3

| | Compound # |
|---|---|
| | E |
| Physical properties of post cure samples | |
| Tensile (PSI) | 787.3 |
| Elongation (%) | 158.9 |
| Duro, Shore “A” | 79 |
| Hot air heat age at 175° C., 70 hours | |
| Tensile (% change) | 0 |
| Elongation (% change) | 0.76 |
| Duro, Shore “A” (points change) | 5 |
| Vol. swell IRM 903, 150 C, 70 hours | |
| Volume swell % | 2.82 |

### Counter Examples 1

| | |
|---|---|
| 33-3 | Nitrile-butadiene rubber. 33% acrylonitrile content. Available from Zeon |
| | Chemicals. |
| Zetpol 4310 | Hydrogenated nitrile butadiene rubber. 17% acrylonitrile content. Available |
| | from Zeon Chemicals. |
| N330 | Carbon black. Available from Degussa Engineered Carbons. |
| Zinc Oxide | Activator. Available from U.S. Zinc. |
| Stearic Acid | Activator. Available from C. P. Hall |
| Naugard 445 | 4,4′-bis(a,-dimethylbenzyl)diphenylamine. Antioxident. Available from |
| | Crompton/Uniroyal Chemical |
| Vanox ZMTI | Zinc 2-mercaptotoluimidazole. Antioxident. Available from R.T. Vanderbilt. |
| Vanax MBM | M-phenylenedimaleimide. Curing agent. Available from R.T. Vanderbilt. |
| Di-Cup 40KE | Dicumyl peroxide on Burgess KE clay. Curing agent available from GEO |
| | Speciality Chemicals. |
| Sulfur | Curing agent. Available from R.E. Carroll |
| CBTS | n-cyclohexyl-2-benzothiazole sulfenamide. Accelerator. Available from |
| | Akrochem. |
| PVI | n-(cyclohexylthio)phthalimide. Pre-vulcanization inhibitor. Available from |
| | Santogard. |
| Thiuram ME 50 | 60% tetramethyl thiuram disulfide, 40% tetraethylthiuram disulfide. |
| | Accelerator. Available from Arrow Polychem. |

Two rubber compounds were prepared on an open two-roll mill according to the formulations in Table 3. After the ingredients were thoroughly incorporated, the compounds were removed from the mill in slabs of appropriate thickness for compression molding into 6″×6″ tensile sheets. The cure conditions for each sample are show in Table 4.

TABLE 3

Counter
Example Number

| | C_A | C_B |
|---|---|---|
| 33-3 | 100 | |
| Zetpol 4310 | | 100 |
| N330 | 85 | 50 |
| Zinc Oxide | 5 | 3 |
| Stearic Acid | 0.5 | |
| Naugard 445 | | 1.5 |
| Vanox ZMTI | | 1 |
| Vanax MBM | | 2 |
| Di-Cup 40KE | | 8 |
| Sulfur | 0.5 | |
| CBTS | 2 | |
| PVI | 0.15 | |
| Thiuram ME 50 | 2 | |

The hot oil swelling resistance and hot air resistance were determined according to ASTM D471-98 and ASTM D2000, respectively. The physical properties of tensile strength at break, elongation at break, and hardness are listed in Table 4 for the cured compounds. After the compounds were aged in air at 175° C. for 70 hrs, the change in tensile strength at break, elongation at break, and hardness were measure and are recorded in Table 4.

TABLE 4

| | Counter Example Number | |
|---|---|---|
| | C_A | C_B |
| Physical properties of cured | 160° C., 15 min | 177° C., 10 min |
| samples Cure conditions | | |
| Tensile @break (PSI) | 2712.1 | 3149.20 |
| Elongation (%) | 198.03 | 237.17 |
| Duro, Shore “A” | 87 | 66 |
| Hot air heat age at 175° C., 70 hrs | | |
| % change Tensile 175 | −66.55 | 9.42 |
| % change elong 175 | −99.90 | −12.70 |
| Duro, Shore “A” (points change) | −1.00 | 10.00 |
| Volume Swell IRM 903, | | |
| 150° C., 70 hrs. | | |
| volume swell % | 13.1 | 41.6 |

In counter example C A the tensile strength drops more than 30% and the elongation drops more than 50% in 175° C. heat aging indicating that the material is not a Type E material according to ASTM D2000. However, the volume swell is less than 20%, which puts this compound in Class J according to ASTM D2000. Thus the volume swell of the material is relatively low, but the material is not stable to heat aging as suggested in Table 4.

In counter example C_B the tensile strength and elongation change less than 30% at 175° C., which classifies the material as a Type E. However, the volume swell is >40% which puts the compound in Class F. Again the material is not resistant to both heat and swelling.

What is claimed is:

1. A composition comprising:
(a) A plurality of crosslinked acrylate microspheres, wherein the crosslinked acrylate microspheres are the reaction product of at least one acrylate monomer and at least one multifunctional crosslinking agent; and
(b) a curable fluoroelastomer.

2. The composition of claim 1, wherein the at least one acrylate monomer is selected from 2 ethylhexyl acrylate, n-octyl acrylate, isooctyl acrylate, 4-methyl-2-pentyl acrylate, 2-methylbutyl acrylate, isoamyl acrylate, sec-butyl acrylate, n-butyl acrylate, isodecyl methacrylate, isononyl acrylate, isodecyl acrylate, tert-butyl acrylate, butyl methacrylate, and mixtures thereof.

3. The composition of claim 2, further comprising polar copolymerizable monomers.

4. The composition of claim 3 wherein the polar copolymerizable monomers are selected from cyanoalkyl acrylates, acrylamides, substituted acrylamides, N-vinyl pyrrolidone, acrylonitrile, ammonium acrylate, acrylonitrile, and N-vinyl caprolactam.

5. The composition of claim 1, further comprising a curative composition.

6. The composition of claim 5, wherein the curative composition is selected to enable curing through a polyol curing mechanism or a free radical curing mechanism.

7. The composition of claim 6, further comprising acid acceptors, fillers, or process aids.

8. The composition of claim 1 wherein the curable elastomer is polymerized from two or more monomers selected from propylene, hexafluoropropylene, vinylidene difluoride, tetrafluoroethylene, and ethylene.

9. The composition of claim 1, wherein the multifunctional crosslinking agent is selected from multifunctional acrylates, polyvinylic crosslinking agent (divinyl benzene), and difunctional urethane acrylates.

10. A composition comprising:
(a) A plurality of crosslinked acrylate microspheres, wherein the crosslinking occurs through the utilization of multifunctional crosslinking agents; and
(b) a cured fluoroelastomer, wherein the plurality of crosslinked acrylate microspheres are dispersed throughout the cured fluoroelastomer.

11. The composition of claim 10, wherein the composition is cured through a polyol curing mechanism or a free radical curing mechanism.

12. The composition of claim 10, further comprising one or more adjuvants selected from carbon black, fillers, or process aids.

13. The composition of claim 10, wherein the temperature resistance as measured by ASTM D2000 is greater than 150° C.

14. The composition of claim 10, wherein the composition exhibits a swell according to ASTM D471 in IRM 903 of about 15% or less.

15. The composition of claim 10, wherein the crosslinked acrylate microspheres exhibit a gel content of 98% or more.

16. A method comprising blending a curable fluoroelastomer and plurality of crosslinked acrylate microspheres, wherein the crosslinked acrylate microspheres are the reaction product of at least one acrylate monomer and at least one multifunctional crosslinking agent.

17. The method of claim 16, wherein the curable fluoroelastomer is a dried gum and the crosslinked acrylate microspheres are physically blended with the dried gum.

18. The method of claim 16, wherein the blending occurs by roll mill, internal mixer, or extruder.

19. The method of claim 16, wherein the curable fluoroelastomer and the plurality of microspheres are both in a latex form.

20. The method of claim 16, wherein the crosslinked acrylate microspheres are the reaction product of a suspension or dispersion polymerization process using an aqueous or organic media.

21. The method of claim 16, further comprising a curative selected to enable curing through a polyol curing mechanism or a free radical curing mechanism.

22. The method of claim 16, further comprising curing the composition.
